(19) United States
(12) Patent Application Publication
(10) Pub. No.: US 2004/0256546 A1
(43) Pub. Date: Dec. 23, 2004

(54) Position-detecting device

(76) Inventors: Chun-Fang Hsiao, Hsinchu City (TW); Shen-Xiang Lin, Taipei City (TW); Chih-Hsiung Shen, Taichung (TW); San-Bao Lin, Jungli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/763,198

(22) Filed: Jan. 26, 2004

(30) Foreign Application Priority Data
Jun. 18, 2003 (TW) 092116585

(51) Int. Cl. G01D 5/34

(52) U.S. Cl. 250/231.13; 250/231.14

(57) ABSTRACT

A position-detecting device is provided. The optical position-detecting device essentially comprises a light-emitting source, a mask, and a light-detecting device, in which a plurality of grating-holes are provided on the mask for allowing of a projecting light source, generated by the light-emitting source, to pass therethrough, and the projecting light source passing through the grating-holes are then absorbed by a plurality of light-detecting element provided on the light-detecting device. Each light-detecting device is provided as a non-rectangular mode, while an interval space is existed between any two of adjacent light-detecting elements. The partially active area of one of the light-detecting elements is naturally provided at the vertical extension of the interval space, and thus diminishing disadvantages of misdetermination and low sensitivity of the light-detecting device induced by the presence of an interval space.

### FIELD OF THE INVENTION

The present invention is related to a position-detecting device, particularly to an optical position-detecting device for diminishing disadvantages of misdetermination and low sensitivity of the light-detecting device induced by the presence of an interval space.

### BACKGROUND

Accordingly, optical position-detecting devices have been widely used in a common computer mouse, cursor indicator, knob, and consumer electronics product, owing to its advantages of high sensitivity, high resolution, convenient signal identification, and reduced noise.

Also, the industry has developed various position-detecting devices for adapting itself to the characteristics of the position-detecting device and the product requirement, such as Taiwan Patent Publication No. 523082, entitled “Detecting Device For Detecting Variance In Position And Angle”, issued to the present applicant.

Referring to FIGS. 1 and 2A, there are shown a perspective diagram and a constructional block diagram, respectively, disclosed in the prior application of the present invention, entitled “Detecting Device For Detecting Variance In Position And Angle”, while referring to FIG. 2B, there is shown a diagram of a light-detecting unit. A position-detecting device comprises a mask 12, a light-emitting source 18, and a light-detecting device 20, where the light source 18 and the light-detecting device 20 are provided at two sides of the mask 12, respectively. A shaft stem 16 to which an external force is applied may be provided in place at the mask 12, and a plurality of grating-holes 14, allowing for a projecting light source 185 of the light-emitting source 18 to pass through, are chiseled at the periphery of the mask. A part of projecting light source 185 may pass through the grating-holes 14 to be a signal light source 187 for irradiating the light-detecting device 20.

The light-detecting device 20 comprises a plurality of light-detecting units 221-224, while each of the light-detecting units further include a power source contact 38 capable of receiving power supply, a first connection terminal 24, a second connection terminal 26, and a light-detecting element (light-sensing element) for absorbing the signal light source 187 (for instance, a light-detecting element 281 of the first light-detecting unit 221). The signal light source 187 may be absorbed by the light-detecting element 281 for the generation of a current signal, and this current signal is then transmitted to a signal selection circuit 32 by means of a current mirror circuit 30. A maximum current selection circuit 322 of the signal selection circuit 32 may be compared with other light-detecting units 222-224, electrically interconnected with that first one, via the first connection terminal 24 to determine which light-detecting elements 281-284 may absorb the largest amount of the signal light source 187. This result may be further converted into a digitally encoded signal by means of a current transforming circuit 326 and a set/reset switch 36. As such, the displacement and the variance in angular of the position-detecting device may be converted accurately based on the aforementioned digitally encoded signal by a user.

Furthermore, the signal selection circuit 32 further comprises a current summation and feedback circuit 324 for determining whether the current inputted from the current mirror circuit 30 is greater than a half of the summation of all the currents originated from the light-detecting elements 281-284, through the second connection terminal 26. Thereafter, this result may be equally converted into a digitally encoded signal by means of the effect of the current transforming circuit 326 and set/reset switch 36. As such, the displacement and the variance in angular of the position-detecting device may be converted accurately based on the aforementioned digitally encoded signal by a user.

Although a satisfactory result from position-detecting detection could be obtained when the above conventional technology is applied to the product, there still exist following disadvantages. Referring to FIGS. 3 and 1, all of the light-detecting elements 281-284 are provided as a rectangular mode, provided in parallel with the light-detecting device 20, and arranged such that an interval space 288 is naturally formed between any two of adjacent light-detecting elements 281-284. A certain width may be provided for the grating-hole 14, due to the mechanism feature of the element, such that the light-irradiated zone irradiated by the signal light source 187 onto the location of the light-detecting device 20 may be larger than the total width of two light-detecting elements, as illustrated by a second light-irradiated zone 182, for example.

As the mask 12 rotates or operates, the light-irradiated zone irradiated by the signal light source 187 onto the light-detecting device 20 is also displaced accordingly, such as the displacement from a first light-irradiated zone 181 to the second light-irradiated zone 182, and then to a third light-irradiated zone 180, in turn. In the first light-irradiated zone 181, it is successful for the signal selection circuit 32 to decide that the first light-detecting element 281 has the largest light-receiving area. In the second light-irradiated zone 182, however, the first light-detecting element 281 and the second light-detecting element 282 have the same light-receiving area, since both of them wholly lie in the light-receiving area at the same time, such that the misdetermination or the reduced sensitivity may be ready to occur. Subsequently, when displaced to the third light-irradiated zone 183, again, it is successful for the signal election circuit 32 to decide that the second light-detecting element 283 has the largest light-receiving area.

Although the detection for the positional displacement may be a combination of a series of decisions, it is also found that the conditions of indeterminability and thus reducing sensitivity, as well as even non-response, are all possible to occur during the light-irradiated zone displaces within its region, owing to the presence of the interval space 288. For some application fields with higher quality requirement for accuracy and sensitivity, this still brings about trouble in use.

For avoiding aforementioned imperfections, of course, the width of the grating-hole 14 may be also reduced to a size incapable of accommodating two light-detecting elements 281, 282 therein simultaneously. Nevertheless, accurately chiseling respective grating-holes 14 on the mask 12 with extremely small volume may be thus required. Consequently, not only higher-level technique, but also significantly increased cost may be needed.

### SUMMARY OF THE INVENTION

Accordingly, how to design a novel position-detecting device for effectively decreasing the effect of sensitivity reduction caused by the presence of an interval space is the key point of the present invention.

It is a primary object of the present invention to provide a position-detecting device capable of effectively solving aforementioned technical disadvantages with which the prior application is confronted.

It is a secondary object of the present invention to provide a position-detecting device allowed for thoroughly solving the bother of indeterminability resulted from the interval space, further effectively raising the degree of accuracy and sensitivity of the product.

It is another object of the present invention to provide a position-detecting device for effectively improving the sensitivity of the product and speeding response time without an increased manufacturing cost.

Therefore, for the purpose of achieving aforementioned objects, the main structure according to one embodiment of the present invention comprises a light-emitting source used for generating a projecting light source; an optical mechanism receiving the projecting light source originated from the light-emitting source, and then generating a signal light source accordingly after processing; and a light-detecting device fixed at one side of the optical mechanism, and having a plurality of light-detecting units provided thereon, each of the light-detecting units including at least one light-detecting element, provided as a non-rectangular mode, used for receiving the signal light source.

Further, the main structure according to another embodiment of the present invention comprises a light-emitting source used for generating a projecting light source; an optical mechanism receiving the projecting light source originated from the light-emitting source, and then generating a signal light source accordingly after processing; and a light-detecting device fixed at one side of the optical mechanism, and having a plurality of light-detecting units provided thereon, each of the light-detecting units including at least one light-detecting element used for receiving the signal light source, wherein between the light-detecting element and a light-irradiated zone projected by the signal light source, an inclined angle is further provided.

Furthermore, the main structure according to still another embodiment comprises a light-emitting source used for generating a signal light source; a mask having a plurality of slant granting-holes allowing for a projecting light source to pass through, while an inclined angle further existing between the slant granting-hole and the center of the mask; and a light-detecting device fixed at one side of an optical mechanism, and having a plurality of light-detecting units provided thereon, each of the light-detecting units including at least one light-detecting element used for receiving the signal light source.

### BRIEF DESCRIPTION OF DRAWINGS

FIG. 1 is a perspective diagram showing the prior application of the present invention;

FIG. 2A is a constructional block diagram showing the prior application of the present invention;

FIG. 2B is a constructional block diagram of each light-detecting unit of the prior application illustrated in FIG. 2A;

FIG. 3 is a light-detecting operation diagram of the prior application illustrated in FIG. 2A;

FIG. 4 is a light-detecting operation diagram according to one preferred embodiment of the present invention;

FIG. 5 is a light-detecting operation diagram according to another embodiment of the present invention;

FIG. 6 is a light-detecting operation diagram according to still another embodiment of the present invention;

FIG. 7 is a light-detecting operation diagram according to yet another embodiment of the present invention;

FIG. 8 is a light-detecting operation diagram according to yet another embodiment of the present invention;

FIG. 9A is a perspective diagram showing yet another embodiment of the present invention;

FIG. 9B is a light-detecting operation diagram according to the embodiment of the present invention illustrated in FIG. 9A; and

FIG. 10 is a constructional block diagram showing yet another embodiment of the present invention.

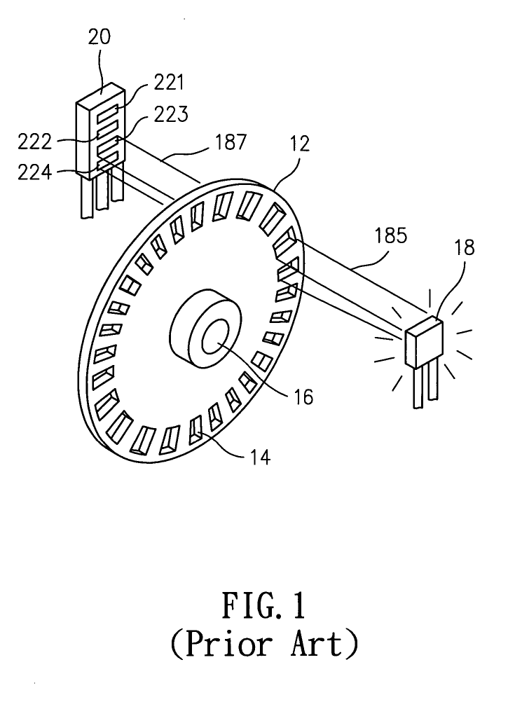

### DETAILED DESCRIPTION

The structural features and the effects to be achieved may further be understood and appreciated by reference to the presently preferred embodiments together with the detailed description.

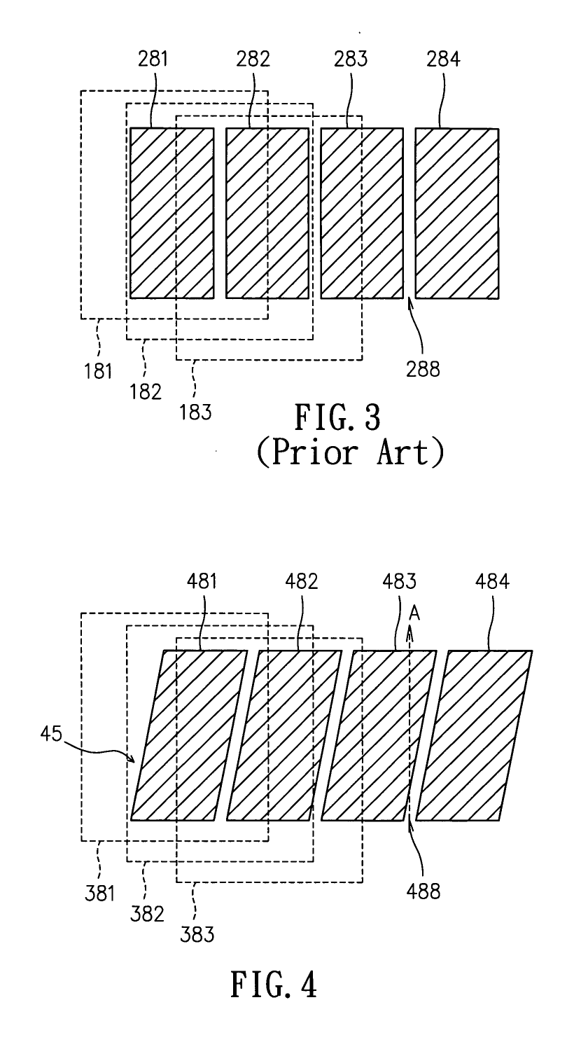

Firstly, referring to FIG. 4, there is shown a light-detecting operation diagram of a position-detecting device according to one preferred embodiment of the present invention. As illustrated in this figure, light-detecting elements originally provided as a rectangular mode are changed to “non-rectangular” light-detecting elements 484-484 according to the present invention. By way of example, each of the parallelogram-like light-detecting elements 481-484, illustrated in this embodiment, are provided in parallel with each other. Although there still exists a interval space 488 between any two of adjacent parallelogram-like light-detecting elements, a partially active area may be provided at the vertical extension of each interval space 488 along the direction of a dashed arrow A, such as an area at the right side of the light-detecting element 483 shown in this figure, for example. In other words, there exists an inclined angle of 45 degrees between the light-irradiated zones 381-383 projected by the signal light source and the light-detecting elements 484-484.

As the signal light source (18) irradiates the light-detecting elements 481-484 of the light-detecting device (20) through the grating-holes (14), the light-irradiated zones thus formed still comprises the first light-irradiated zone 381, second light-irradiated zone 382, and third light-irradiated zone 383, which are the same as those of the prior application. For the first and third light-irradiated zones 381 and 383, it is definite to decide that the first and third light-detecting units 481 and 483 have the maximum light-receiving area, respectively. As for the controversial second light-irradiated zone 382, the combined light-receiving area composed of the first and second light-detecting elements 481 and 482 is enlarged, such that the inclusion of two light-detecting elements 481, 482 within the identical light-irradiated zone 382 at the same time seldom occurs.

When the region of light-irradiated zone displaces from the first light-irradiated zone 381 to the second light-irradiated zone 382 and then arrives at the third light-irradiated zone 383 via crossing the interval space 488 in turn, even though two light-detecting elements 481, 482 are arranged such that both of them could exist within the region of a light-irradiated zone 382 simultaneously, however, at lest one light-detecting element 481 may have a reduced light-receiving area, and at least one light-detecting element 482 may correspondingly have an increased light-receiving area, resulting in that only at one time the first and second light-detecting elements 481 and 482 have an identical light-receiving area, owing to the partially active areas of light-detecting elements 481-484 existed on the vertical extension A of the interval spaces 488. This structure may be not the same as that of prior application having an active are with one interval space (288), due to the fact that the timing is practically an unsteadily immediate threshold. Therefore, it is easy for the signal selection circuit (32) to decide which one of the light-detecting elements 481-484 has a larger light-receiving area and thus reactively generated current by comparison. Correspondingly, the displacement or the variance in angular of the detecting device could be converted fast and accurately.

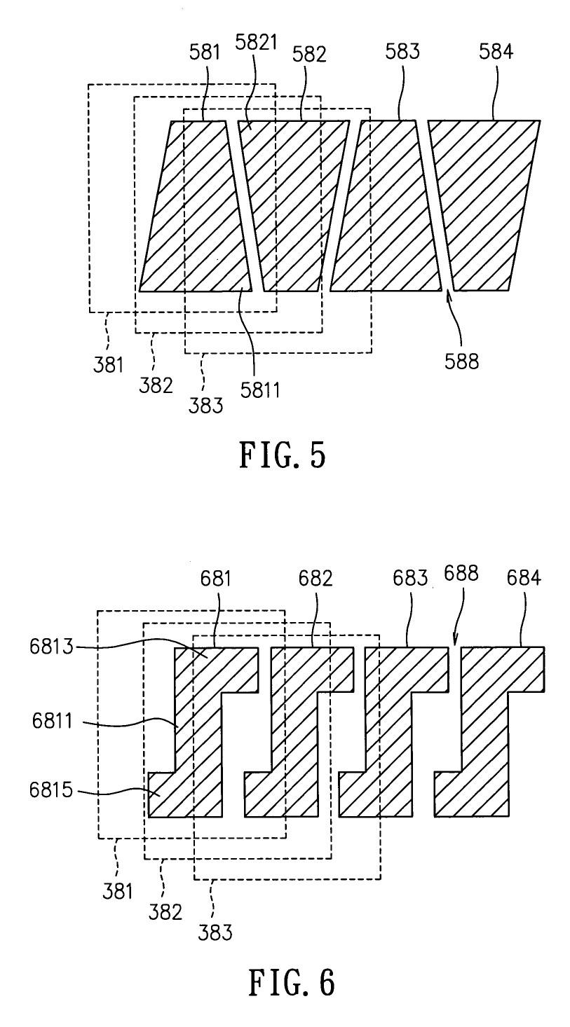

Furthermore, referring to FIG. 5, there is shown a light-detecting operation according to another embodiment of the present invention. In this present embodiment illustrated in this figure, there is mainly a modification with respect to the light-detecting elements, in which trapezoid-like light-detecting elements 581-584, any two of the adjacent trapezoid-like light-detecting elements 581,582 (or 582,583; 583,584) being disposed in an inverted manner, are formed. As such, partially light-receiving areas of the trapezoid-like light-detecting elements 581-584 are equally provided in the vertically extending direction of the interval spaces 588. In this embodiment, even a long bottom side 5821 of the second light-detecting element 582 may be further provided in the vertically extending direction of a long bottom side 5811 of the first light-detecting element 581. Thereby, as displaced from the first light-irradiated zone 381 to the second light-irradiated zone 382 and then arriving at the third light-irradiated zone 383 in turn, there is only an immediate threshold where the first light-detecting element 581 and the second light-detecting element 582 have an identical light-receiving area. Thus, the advantage of effectively raising operational sensitivity may be also obtained.

In addition, referring to FIG. 6, there is shown a light-detecting operation diagram according to still another embodiment of the present invention. In this present embodiment illustrated in this figure, there are mainly light-detecting elements 681-684 designed so as to include vertical sections 6811. Two ends of the vertical section 6811 are extended horizontally along different directions, respectively, to form a first horizontal section 6813 and a second horizontal section 6815. The length of the first horizontal section 6813 is greater than that of the second horizontal section 6815. Each of the light-detecting elements 681-684 may be placed in a parallel manner, while the first horizontal section 6813 or the second horizontal section 6815 of each of the light-detecting elements 681-684 may be permanently existed in the vertically extending direction of the interval space 688.

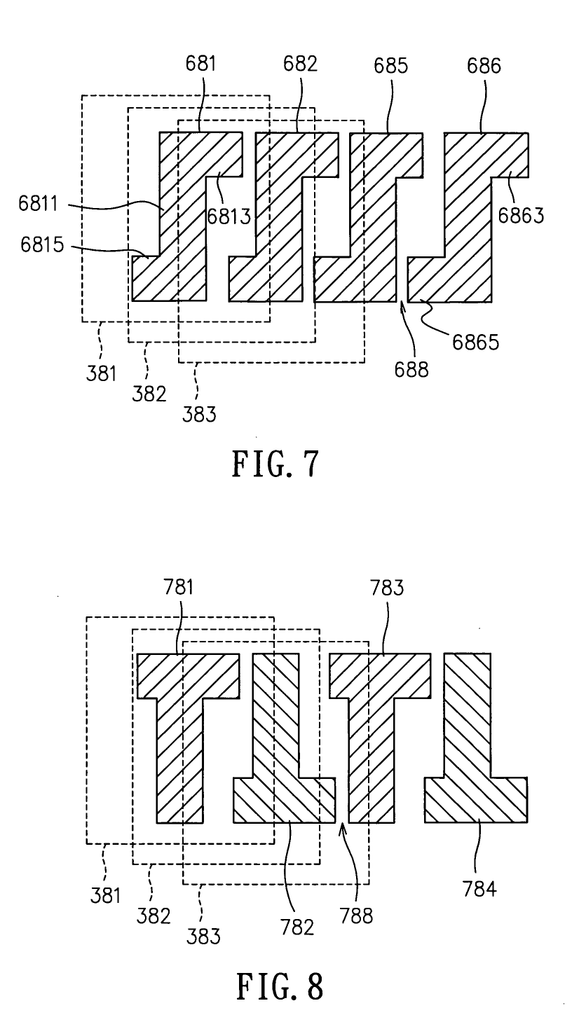

Further, referring to FIG. 7, there is shown a light-detecting operation diagram according to yet another embodiment of the present invention. In this present embodiment illustrated in this figure, there is mainly a third light-detecting element 685 inversely disposed to be inverted with the second light-detecting element 682. However, a first horizontal section or a second horizontal section 6865 is still necessary provided in the vertically extending direction of the interval space 688. Additionally, the first horizontal section 6863 may also have a length being equal to that of the second horizontal section 6865.

Furthermore, referring to FIG. 8, there is shown a light-detecting operation diagram according to yet another embodiment of the present invention. In this present embodiment illustrated in this figure, there is mainly a modification to the light-detecting elements, in which “T” type light-detecting elements 781-784 are formed. Any two of the adjacent “T” type light-detecting elements 781-784 are disposed in an inverted manner. Partially active areas of the light-detecting elements 781-784, however, are still provided at vertical extension of interval spaces 788.

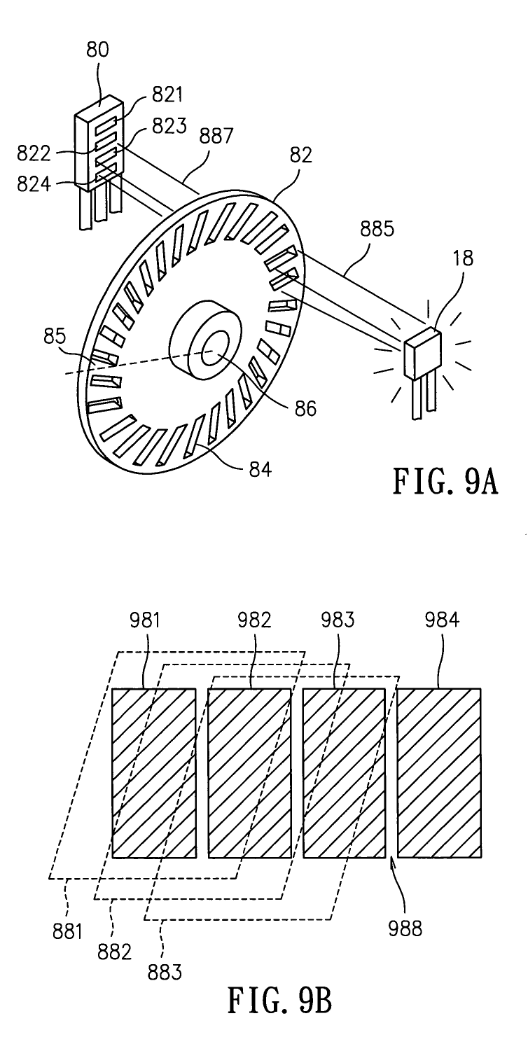

Further, referring to FIGS. 9A and 9B, there are shown a perspective diagram and a light-detecting operation diagram, respectively, according to yet another embodiment of the present invention. As illustrated in these figures, the position-detecting device of the present invention equally comprises an optical mechanism 82, such as a mask having a shaft stem or shaft hole 86 provided at the center thereof and a plurality of grating-holes 84 provided at the periphery thereof. Likewise, a light emitting source and a light-detecting device 80 are provided at two sides of the mask 82, respectively, while a plurality of light-detecting units 821-824 are provided on the light-detecting device 80. Moreover, a plurality of light-detecting elements 981-984 are equally provided on each of the light-detecting units 821-824, respectively.

In this embodiment, there are mainly slant granting-holes 84 arranged such that each grating-hole 84 of the mask 82 may be inclined by an angle. Each of the slant grating-holes 84 are inclined by an inclined angle 85 with respect to the center or diametrical line of the mask 82. In this manner, light-irradiated zones 881-883 irradiated by a signal light source 887 onto the light-detecting elements 981-984 may have an inclined angle when the formation of the signal light source is achieved by a projecting light source 885, generated by the light-emitting source 88 and then passing through the slant grating-holes 84. Whereby, even in the case of rectangular light-detecting element 981-984, the condition of at least one light-detecting element 981 having a reduced light-receiving area while at least one light-detecting element 982 correspondingly having an increased light-receiving area may still turn up when crossing the interval space 988, because all of the first, second, and third light-irradiated zones 881, 882, and 883 are inclined active areas. As such, it is equally easy for identifying the size of light-receiving area as well as the value of current, in order for obtaining the advantage of raising sensitivity of the element.

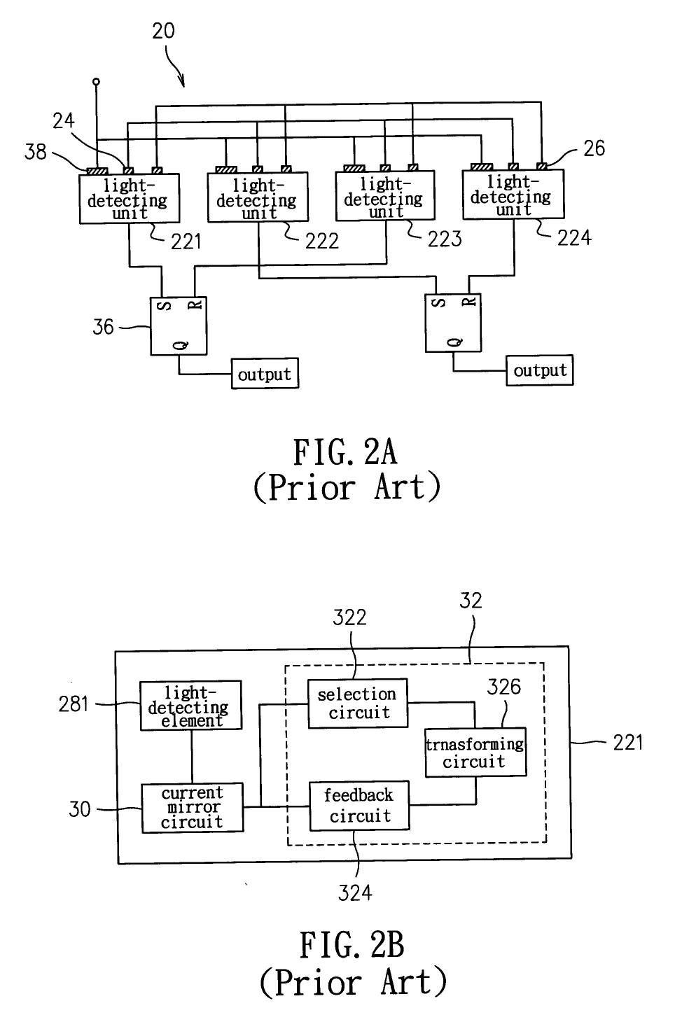

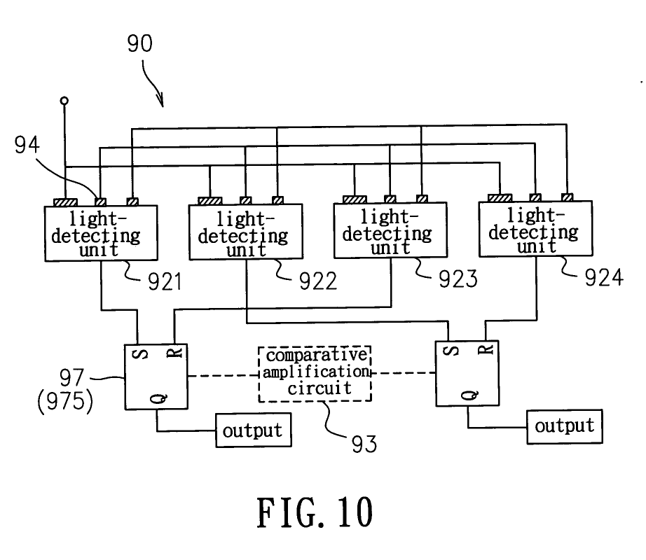

Finally, referring to FIG. 10, there is shown a constructional block diagram according to yet another embodiment of the present invention. As illustrated in this figure, various embodiments described in the present invention are equally applied to the technique of the invention, disclosed in the issued Taiwan Patent Publication No. 523082, entitled “Detecting Device For Detecting Variance In Position And Angle”. Likewise, a light-detecting device 90 comprises a plurality of light-detecting units 921-924, and each of the light-detecting units 921-924 are interconnected via a first connection terminal 94. Further, by means of a maximum current selection circuit (952) in one signal selection circuit (for instance, “32” shown in FIG. 2B), one of the light-detecting units 921-924 with the largest light-receiving area and thus generated current may be selected once, and then a first or second logic signal will be selected accordingly. Finally, a correspondingly digital signal may be formed via conversion by the set/reset switch 97. The present invention may be adapted to a comparative amplification circuit configuration, of course, only a comparative amplification circuit for current 975 designed for the set/reset switch 97 is needed. By means of repeated comparison performed by individual comparative amplification circuits 975, 93 with respect to each of the light-detecting units 921-924, one of the light-detecting units 921-924 with maximum current could be obtained. Through repeated comparisons, the displacement and the variance in angular of the position-detecting device may be similarly converted accurately.

To sum up, the present invention is related to a position-detecting device, particularly to an optical position-detecting device for diminishing disadvantages of misdetermination and low sensitivity of the light-detecting device induced by the presence of an interval space. Therefore, this application is filed in accordance with the patent law duly, since the present invention is truly an invention with novelty, advancement or non-obviousness, and availability by the industry, thus naturally satisfying the requirements of patentability. Your favorable consideration will be appreciated.

The foregoing description is merely one embodiment of present invention and not considered as restrictive. All equivalent variations and modifications in process, method, feature, and spirit in accordance with the appended claims may be made without in any way from the scope of the invention.

### LIST OF REFERENCE SYMBOLS

12 mask

14 grating-hole

16 shaft stem

18 light-emitting source

181 first light-irradiated zone

182 second light-irradiated zone

183 third light-irradiated zone

185 projecting light source

187 signal light source

20 light-detecting device

221 first light-detecting unit

222 second light-detecting unit

223 third light-detecting unit

224 fourth light-detecting unit

24 first connection terminal

26 second connection terminal

281 first light-detecting element

282 second light-detecting element

283 third light-detecting element

284 fourth light-detecting element

288 interval space

30 current mirror circuit

32 signal selection circuit

322 maximum current selection circuit

324 current summation and feedback circuit

326 current transforming circuit

36 set/reset switch

38 power source contact

381 first light-irradiated zone

382 second light-irradiated zone

383 third light-irradiated zone

45 inclined angle

481 first light-detecting element

482 second light-detecting element

483 third light-detecting element

484 fourth light-detecting element

488 interval space

581 first light-detecting element

5811 long bottom side

582 second light-detecting element

5821 long bottom side

583 third light-detecting element

584 fourth light-detecting element

588 interval space

681 first light-detecting element

6811 vertical section

6813 first horizontal section

6815 second horizontal section

682 second light-detecting element

683 third light-detecting element

684 fourth light-detecting element

685 third light-detecting element

686 fourth light-detecting element

6863 first horizontal section

6865 second horizontal section

688 interval space

781 first light-detecting element

782 second light-detecting element

783 third light-detecting element

784 fourth light-detecting element

788 interval space

80 light-detecting device

82 mask

821 first light-detecting unit

822 second light-detecting unit

833 third light-detecting unit

824 fourth light-detecting unit

84 slant granting-hole

85 inclined angle

86 shaft hole

881 first light-irradiated zone

882 second light-irradiated zone

883 third light-irradiated zone

885 projecting light source

887 signal light source

90 light-detecting device

921 first light-detecting unit

922 second light-detecting unit

923 third light-detecting unit

924 fourth light-detecting unit

93 comparative amplification circuit

94 first connection terminal

97 set/reset switch

975 comparative amplification circuit

981 first light-detecting element

982 second light-detecting element

983 third light-detecting element

984 fourth light-detecting element

988 interval space

1. A position-detecting device, comprising:
a light-emitting source for generating a projecting light source;
an optical mechanism for receiving said projecting light source originated from said light-emitting source, and generating a signal light source after processing; and
a light-detecting device, fixed at one side of said optical mechanism, and having a plurality of light-detecting units provided thereon, each of said light-detecting units including at least one light-detecting element, provided as a non-rectangular mode, for receiving said signal light source.

2. The position-detecting device according to claim 1, wherein between any two of said adjacent light-detecting elements are provided interval space, and at a vertical extension of each interval space having a partially active area of one of said light-detecting elements is provided.

3. The position-detecting device according to claim 1, wherein said light-detecting element is provided as a parallelogram mode, and any two of said adjacent parallelogram-like light-detecting elements are provided in parallel with each other.

4. The position-detecting device according to claim 1, wherein said light-detecting element is provided as a trapezoid mode, and any two of said adjacent trapezoid-like light-detecting elements are disposed in an inverted manner.

5. The position-detecting device according to claim 4, wherein a long bottom side of said trapezoid-like light-detecting element is provided at a vertical extension of a bottom side of said adjacent light-detecting element.

6. The position-detecting device according to claim 1, wherein said light-detecting element comprises a vertical sections, a first horizontal section disposed at one end of said vertical section and extending toward one horizontal direction, and a second horizontal section disposed at the other end of said vertical section and extending toward the other horizontal direction.

7. The position-detecting device according to claim 1, wherein said second horizontal section of said light-detecting element is provided at a vertical extension of said first horizontal section of said adjacent light-detecting element.

8. The position-detecting device according to claim 6, wherein the length of said first horizontal section is equal to that of said second horizontal section.

9. The position-detecting device according to claim 6, wherein the length of said first horizontal section is greater than that of said second horizontal section.

10. The position-detecting device according to claim 1, wherein said light-detecting element is provided as a “T”-shaped mode, and any two of said adjacent “T”-shaped light-detecting elements are disposed in an inverted manner.

11. The position-detecting device according to claim 1, wherein each of said light-detecting units further comprising a signal selection circuit, one of said light-detecting units provided with a light detecting element receiving the largest amount of signal light source allowed for transmitting a first logic signal, and others allowed for transmitting a second logic signal.

12. The position-detecting device according to claim 11, wherein the amount of signal light source received by said light-detecting element is determined via a selection performed just once by a maximum current selection circuit.

13. The position-detecting device according to claim 11, wherein the amount of signal light source received by said light-detecting element is determined via a selection performed at least once by at least one comparative amplification circuit.

14. The position-detecting device according to claim 1, further comprising a set/reset switch used for converting what is selected from the group consisting of said first logic signal, said second logic signal, and the combination thereof into a digital signal.

15. The position-detecting device according to claim 1, wherein said optical mechanism is a mask, and a plurality of grating-holes are chiseled at the periphery of said mask.

16. The position-detecting device according to claim 1, wherein said position-detecting device is applied to what is selected from the group consisting of a cursor indicator, a mouse, a knob, and the combination thereof.

17. A position-detecting device, the main structure thereof comprising:
a light-emitting source for generating a projecting light source;
an optical mechanism for receiving said projecting light source originated from said light-emitting source, and generating a signal light source after processing; and
a light-detecting device, fixed at one side of said optical mechanism, and having a plurality of light-detecting units provided thereon, each of said light-detecting units including at least one light-detecting element, wherein between said light-detecting element and a light-irradiated zone projected by said signal light source, an inclined angle is provided.

18. The position-detecting device according to claim 17, wherein said light-detecting element is provided as a non-rectangular mode.

19. The position-detecting device according to claim 17, wherein between any two of said adjacent light-detecting elements are provided interval space, and at a vertical extension of each interval space having a partially active area of one of said light-detecting elements is provided.

20. A position-detecting device, the main structure thereof comprising:
a light-emitting source for generating a signal light source;
a mask provided with a plurality of slant granting-holes for allowing of said signal light source to pass through, while between said slant granting-holes and the center of said mask an inclined angle provided; and
a light-detecting device, fixed at one side of said optical mechanism, and having a plurality of light-detecting units provided thereon, each of said light-detecting units including at least one light-detecting element, provided as a non-rectangular mode, for receiving said signal light source.

21. The position-detecting device according to claim 20, wherein a non-rectangular light-irradiated zone is formed on said light-detecting device by said signal light source after passing through said slant granting-hole.

22. The position-detecting device according to claim 20, wherein said light-detecting unit is provided as a rectangular mode.
